(19) United States
(12) Patent Application Publication
(10) Pub. No.: US 2010/0030648 A1
(43) Pub. Date: Feb. 4, 2010

(54) SOCIAL MEDIA DRIVEN ADVERTISEMENT TARGETING

(75) Inventors: Dragos Manolescu, Kirkland, WA (US); Raymond Laghaeian, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/184,254

(22) Filed: Aug. 1, 2008

(51) Int. Cl. G06Q 30/00

(52) U.S. Cl. 705/14.66; 705/10

(57) ABSTRACT

Techniques and systems for selecting one or more advertisements to target (e.g., send to, display to, etc.) a user are disclosed wherein the interests of the user are inferred based on current behaviors of social media. Social media is collected and categorized according to some predetermined criteria, such as keywords or outlinks in a post. As a function of the social media collected, current topics in the social media are identified and an advertisement, or advertisements, relating to the current topics is selected. Current topics may be those topics that are more popular, for example, in the social media at the instant a user enters an ad-enabled site.

### BACKGROUND

Online advertising is one of the newest forms of advertising. It allows a website that hosts the advertisement to generate revenue that supports further development of the website. For companies that wish to promote a product and/or service, online advertising can reach more people (e.g., anyone with access to the website it is hosted on) and be more cost effective than traditional newspaper, magazine, or television advertisements, for example.

An online advertisement that is targeted to a particular user is more effective at capturing the user's interest than a randomly selected advertisement. Traditionally, a targeted advertisement is delivered to a user based on cookies and/or other identifiable information about the user. There are two problems with using this criterion to select an advertisement. First, some users have no identifiable information (e.g., such as when a user has cleared his cookies or hides his identity) that may be used to select an advertisement. Second, cookies and/or other identifiable information about the user reflect what the user was previously interested in and may not reflect what the user is currently interested in.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, one or more techniques are disclosed for selecting an online advertisement as a function of social media (e.g., blogs, weblogs, usenet, microblogs, message board forums, etc.). The social media provides a means of assessing current topics (e.g., current, popular conversational topics). Inferences may be made about new and/or modified posts and at a predetermined time and/or upon the occurrence of a predetermined event, a snapshot of the inferences made about the social media at that instant may be captured. Inferences may analyze and group posts into topics according to some predetermined criteria, such as keywords, content of pages pointed to by links in the posts, emotional charge of the posts, etc. Additionally, information about the author of a post may be computed (e.g., age, sex, location, etc.). When the snapshot is taken, current topics may be identified and a user's interests may be predicted (e.g., as a function of the interests of a majority of users meeting some criteria). For instance, if a high percentage of the social media is discussing a new mobile phone (e.g., because the specifications for the forthcoming model were released) when the snapshot is taken, it may be predicted that the user is also interested in the new phone.

Based on the predicted interests the user, one or more advertisements may be selected that relate to a hot topic, for example, that the user is likely to be interested in. A selected advertisement, or advertisements if an ad-enabled site is capable of displaying multiple advertisements, may be displayed on the ad-enabled site (e.g., a site capable of displaying advertisements) the user is viewing.

Information that is known about the user, such as the user's past interests, the website the user was viewing prior to entering the ad-enabled site, and/or the user's demographics, for example, may be used to enhance the prediction. For example, if it is known that the user is a female, based on cookies stored on the user's computer, the topics that generate positive reactions from females are used to make a prediction about the user (e.g., topics popular among men may be different than topics popular among females, and a user's predicted interest will be based on topics popular among females).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of selecting an online advertisement to target a user.

FIG. 2 is a flow chart illustrating an exemplary method of selecting an online advertisement to target.

FIG. 3 is a component block diagram illustrating an exemplary system for selecting an online advertisement to target a user.

FIG. 4 is an illustration of an exemplary computer-readable medium comprising processor-executable instructions configured to embody one or more of the provisions set forth herein.

FIG. 5 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

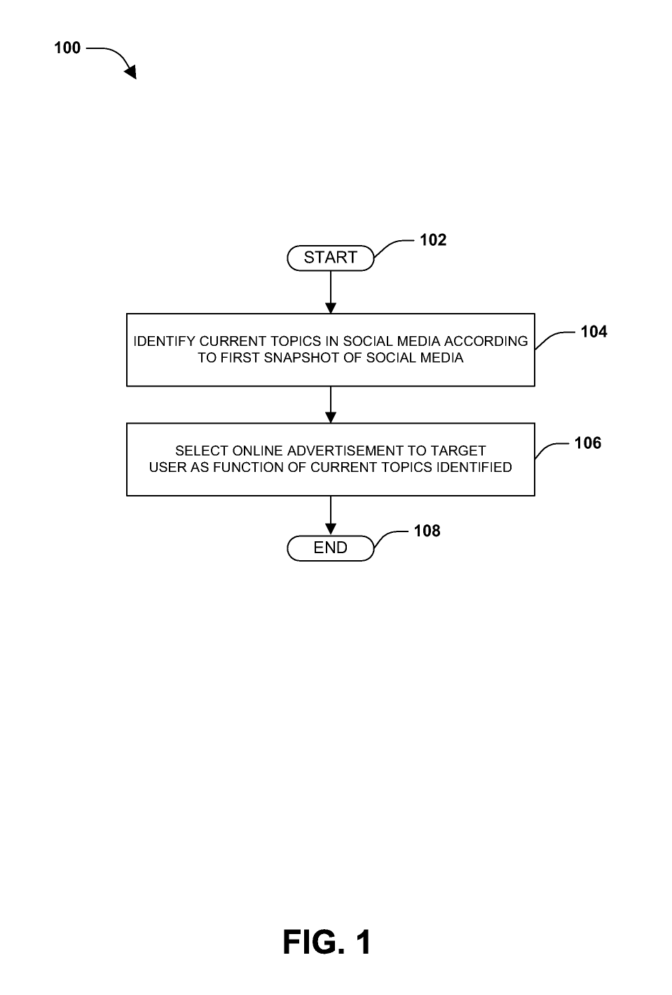

Turning initially to FIG. 1, an exemplary methodology 100 is illustrated for selecting an online advertisement to target a user. The example method 100 begins at 102 and current topics in social media are identified according to a first snapshot of the social media, at 104. It will be appreciated that the term “social media” is used in a broad sense herein to describe or comprise, among other things, blogs, microblogs and message board forums. Current topics, as used herein, may be topics that are more popular in the social media or more relevant to a particular issue in the news, among other things. Current topics may be identified using algorithms and rules trained to infer information about the posts being written when the snapshot is taken. Inference algorithms may be trained, for example, to assign some meaning to particular terms, such as people/places/brands in the post and/or content of the page pointed to by an outlink (e.g., links in the post that point to another site) is often associated with. In one example, the inference component infers the person covered in the social media content (e.g., a person that is discussed more, relative to other topics) of a post. It will also be appreciated that inferences algorithms may continuously extract new information about the posts and the snapshot simply acquires data about the inferences made at the instant the snapshot is taken. The inferences captured when the snapshot is taken may be grouped together into topics and current topics (e.g., topics that are popular among social media authors) may be identified. For example, inference algorithms may be trained to assign posts that contain the term “football” to a category on sports. More complex algorithms may also be utilized to further narrow the scope of the posts and/or extract more topics from the post.

Taking a snapshot of the social media allows the topics of interest to be identified based on what is being written in the social media at that particular instant, whereas detecting a trend and/or a surge in activity with regard to a category uses data over some time period to make a determination. Accordingly, the snapshot technique employed herein makes little to no use of historic social media, or rather the state of social media at previous points in time.

In one embodiment, topics are ranked according to some predetermined criteria after the first snapshot has been taken. For example, topics may be ranked according to how many blog posts relate to that topic (e.g., how popular that topic is relative to other topics). In another example, topics are ranked according to how many posts linking to a product or service's page have a positive emotional charge (e.g., the social media authors like the product or service). In yet another example, fewer than all topics are ranked, such as when the website that the advertisement is going to be displayed on is a book site (e.g., categories related to books may be ranked, but other categories may not be ranked).

At 106, an online advertisement is selected as a function of the current topics identified. For example, an online advertisement may be selected that relates to a more a popular topic or two topics (e.g., relative to other topics), wherein topics are ranked according to popularity. In another example, an advertisement is selected that is more relevant to a group of topics. For instance, if the Olympics and the 2008 election are both identified as current topics, an advertisement about a presidential candidate who is in favor of boycotting the Olympics may be selected. It will be appreciated that the selection process may be done manually and/or automatically. In one example, a person selects which advertisement is displayed to users that enter an ad-enabled site within a predetermined period of time (e.g., users that enter the ad-enabled site within the next hour). In another example, advertisements are tagged as corresponding to a particular topic and/or topics, stored in a storage component, and selected automatically. Selecting an advertisement automatically may, for example, enhance the ability to reflect current behaviors through the advertisements selected by allowing snapshots to be taken more frequently, for example, and advertisements selected corresponding to the more frequent snapshots. Those skilled in the art will appreciate that where a website is capable of displaying multiple advertisements, multiple advertisements may be selected and displayed.

In one embodiment, the blogosphere is monitored by ping servers and syndication feed crawlers extract new or modified blog posts in real-time. It will be appreciated that the blogosphere may be continuously monitored, blog posts extracted, and inferences made about the content of the blog posts according to links and keywords in the posts. For example, it may be inferred that football is a topic of a post if the post contains an outlink that points to an article about football. Additionally, inferences may be made about the author's favorite player and/or what brand of jersey the author's favorite player is wearing based upon keywords in the posts. If at the instant the user makes that post a user enters an ad-enabled site and a snapshot of the social media is taken, the inferences made about that post and other posts may be collected. If multiple people (e.g., 50% of the social media authors) are writing blogs about that same player, the player may be identified as a current, popular conversational topic and an advertisement may be selected that relates to football and/or the brand of jersey that player wears or endorses.

It will further be appreciated that a user's known information may be used to filter the current topics identified at 104 to those that are more likely relevant to the user. In one example, posts written by social media authors about the same geographical location as the user's location are used to identify current topics (e.g., improving the likelihood that an advertisement will target the user). For example, specifications for a new type of fleece used in areas where temperatures reach negative forty degrees below zero may generate a lot of posts from people in Alaska. If the posts written about the fleece, or containing an outlink to a website selling the fleece, mention Alaska, it may be detected that posts discussing the fleece originated in Alaska. If a user from Alaska (e.g., with an internet protocol address from Alaska) enters an ad-enabled site, a snapshot of the social media may be taken and current topics may be identified as a function of posts containing the term “Alaska.” Therefore, if this snow fleece is a current topic of discussion among social media authors who mention the term “Alaska” in their posts an advertisement relating to the fleece, snow clothing, or the company that makes the snow fleece may be selected, despite being a less popular topic, for example, across multiple geographic locations.

In another example, a user's age range can be used to identify current topics that are more likely to be relevant to the user. A user's age range may be predicted, for example, based on previous searches conducted on the ad-enabled site. When the user returns to the ad-enabled site, a snapshot of the social media may be taken and a query conducted to identify current topics among social media authors of the same age range (e.g., wherein an author's age range is predicted based on inferences made about his/her post(s)). An advertisement may be selected that reflects the current, popular conversational topics, for example, among people of the same age range.

In yet another example, a user comes to the ad-enabled site from a site about books (e.g., a referral site). Since it is known that the user was visiting a book site and might be interested in books, an advertisement relating to a topic about newly released books (e.g., a more popular topic relating to books) may be selected.

It will further be appreciated that negative and positive reactions to sites and/or advertisements that have previously been selected may affect which advertisements are selected and/or which ad-enabled sites advertisements are displayed on. For example, if a topic is more popular than other topics but is also receiving more negative sentiment than other topics (e.g., people dislike something pertaining to the topic), an advertisement relating to the topic may not be selected. Displaying an advertisement related to a topic people dislike is unlikely to effectively target a user, for example.

A second snapshot of the social media may be taken some predetermined time after the first snapshot and/or upon the occurrence of some predetermined event. For example, a second snapshot may be taken three minutes after the first snapshot was taken. In another example, a second snapshot may be taken upon a user entering an ad-enabled site (e.g., a site that presents advertisements to a user). By taking snapshots at various intervals, current (non-stale) topics that are apparent in the social media may be captured and used to target advertisements that reflect those contemporary behaviors.

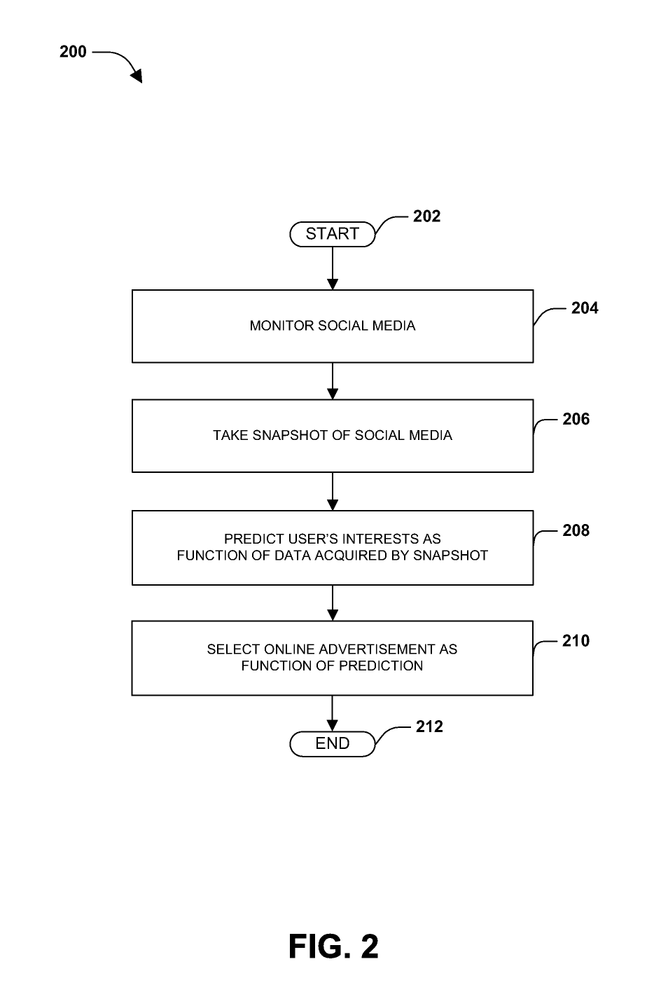

FIG. 2 is an exemplary method 200 for selecting an online advertisement to target a user. The method being at 202. At 204, social media is monitored. The monitoring may be limited to a segment of the social media (e.g., blogs relating to a particular topic, blogs relating to services, etc.). From the social media monitored, new or modified posts, for example, may be extracted. In one example, ping servers are monitored and feeds crawled in response to ping events. For social media that does not provide regular pings, scheduled crawling may be performed. Partial feeds may be augmented with an intelligent scraping mechanism, for example, which parses the structure of the permalink page (e.g., the page containing the post), extracting the complete content of the post. Inferences may be made about the posts acquired. In one example, inferences are made using rules and algorithms that can be trained to detect particular things in the post. For example, the algorithms may detect what topics are covered by the post according to keywords in the post or links extracted in the post. This information may be stored in a database to be recalled later (e.g. when a user enters an ad-enabled site). Other algorithms (more complex algorithms) may also be used to infer the sentiment of the author regarding a topic in the post and/or to infer the demographics of the author.

At 206, a snapshot of the social media is taken. A snapshot may be taken after a predetermined amount of time and/or upon the happening of a predetermined event. It will be appreciated that a snapshot acquires data about what is happening in the social media at the instant the snapshot is taken and does not utilize data gathered over some time continuum. In one example, the snapshot acquires data about which topics are popular. In another example, the snapshot acquires data about which sites a particular age range of social media authors are commonly linking to (e.g., using link extraction). In yet another example, the people, places, and/or brands social media authors are currently writing about are captured by the snapshot.

At 208, a user's interests are predicted as a function of ranked topics acquired by taking the snapshot of the social media. It will be appreciated that the term “interests” is used in a broad sense herein to describe or comprise, among other things, wants, and curiosities. In one example, topics that are predicted to be of more interest to the user are those that are ranked higher (e.g., more popular as it relates to the number of posts categorized as relating to that topic relative to the amount of posts categorized as relating to other topics). In another example, the user's interests are predicted based on how emotionally charged a topic is relative to other topics (e.g., the content of the posts in a given topic comprise more emotionally charged language than other topics). Since the prediction relies on a snapshot of the social media, a subsequent snapshot, taken at a subsequent instant may predict that a user is interested in different topics than the current snapshot. This allows current behaviors in social media to be reflected in the user's predicted interest. For example, if a new product is released and social media authors begin to write posts about it, a topic related to the new product may be ranked higher (e.g., and be of more interest to a user) than it was prior to the new product being released.

It will be appreciated that the prediction may be enhanced when information about the user is available. Information about the website the user was on prior to entering the ad-enabled site (e.g., a site where an advertisement may be displayed), for example, may be used to alter a topics rank. In one example, it may be predicted that a user is interested in romantic novels targeted to 20-30 year olds, if the user has previously been on the ad-enable site (e.g., a website that sells books) and viewed pages about other romantic novels targeted to that age group. Therefore, it may be predicted that the user will be interested in topics that other 20-30 year olds who read romantic novel are currently interested in.

It will also be appreciated that a user's sentiment about a topic may be predicted. For example, if the sentiment of the authors is inferred from the posts (e.g., the sentiment of the social media is extracted) at 204, it may be predicted that a user will dislike topics that are disliked by the authors of the posts. In one example, a topic on sports utility vehicles may be receiving a lot of discussion in the social media, but it is negative discussion, so it may be predicted that a user will have a negative reaction to sports utility vehicles as well and thus advertisements for this topic will not be surfaced.

The demographics of the user (e.g., gathered from cookies, how the user types, etc.) may also be used to improve the prediction of the user's interests. For example, if it is known that a user is from New York (e.g., based on the internet protocol address of the user), posts written by New Yorkers (e.g., as inferred at 204 based upon landmarks discussed in the post, restaurant names in the post, etc.) may be used to predict the user's interests. That is, the prediction may be based on what topics are ranked higher amongst social media authors writing about New Yorker. The rest of the social media content may be ignored, for example, when making a prediction about a user that is known to be in New York.

At 210, an advertisement is selected as a function of the user's predicted interests. The advertisement that is selected may relate to a topic that is ranked higher at 208. The advertisement that is selected may be presented to the user through an ad-enabled site. In one example, advertisements are tagged as relating to a particular topic and/or topics and stored in a storage compartment. When the user enters the ad-enabled site, a snapshot of the characteristics of the social media (e.g., what topics are being discussed as inferred at 204) may be taken, and a prediction of the user's interests may be made, for example. From this prediction, an advertisement may be selected and presented to the user in the ad-enabled site. It will be appreciated that where multiple advertisements may be displayed to a user at once, multiple advertisements may be selected as a function of the user's predicted interest. The advertisements selected may relate to one or more topics being discussed in the social media.

It will be appreciated that where an advertisement and/or a website, for example, receive a negative reaction from the social media (e.g., it is predicted that a user may dislike them), a different and/or no advertisement may be displayed. For example, even if an advertisement relates to a topic that is popular, for example, in the social media, the advertisement may not be selected if it has received a negative reaction from social media authors. In another example, advertisements are not displayed to a user on an ad-enabled site when the site is receiving negative reaction. This may ensure that advertisements are received positively, for example. At 212, the method ends.

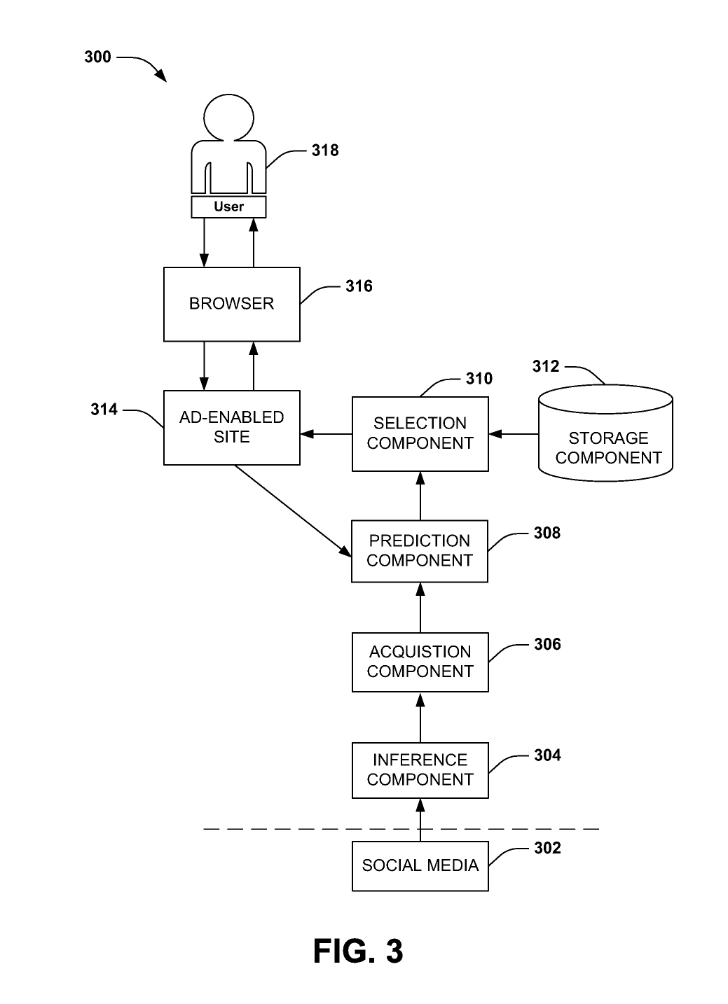

FIG. 3 is a schematic block diagram of an exemplary system 300 configured to select an online advertisement to target a user. That is a system for determining which advertisement to display to a user when a user enters an ad-enabled site (e.g., a site that supports advertisements).

The system 300 comprises an inference component 304 configured to make inferences about social media, an acquisition component 306 configured to take a snapshot of the inferences made by the inference component 304, a prediction component 308 configured to predict a user's 318 interests as a function of the snapshot taken by the acquisition component 306, and a selection component 310 configured to select the online advertisement that relates to the user's 318 predicted interests.

The inference component 304 makes inferences about source media 302 (e.g., blogs, microblogs, message board forums, etc.). In one example, the social media is continuously monitored through syndication feed crawlers that crawl the social media 302 in response to pings that indicate a new post has been created and/or a post has been modified. The inference component 304 may extract posts from the social media and/or search for some predetermined content in the posts. The predetermined content may include, for example, keywords (e.g., names, locations, brands, etc.) and/or links that point to other pages. The inference component may also use natural language processing algorithms and techniques to determine the sentiment of the author with regards to a particular topic, product, and/or service. Algorithms may also be used to compute the demographics (age range, location, etc.) of the author.

The acquisition component 306 takes a snapshot of the inferences made by the inference component 304 upon the occurrence of a predetermined event (e.g., such as a user entering an ad-enabled site) and/or at predetermined time intervals (e.g., every five minutes). The snapshot collects the inferences made by the inference component 204 at the instant the snapshot is taken. It will be appreciated that less than all of the inferences made by the inference component may be collected by the snapshot. For instance, that snapshot may only acquire data that relates to topics on the Olympics (e.g., if the user is on an ad-enabled site about the Olympics).

The prediction component 308 makes a prediction about the user's 318 interests as a function of the snapshot taken by the acquisition component 306. In one example, the prediction component 308 uses the snapshot taken by the acquisition component 306 to determine what the hot topics (e.g., what is more popular) are at that instant. In another example, the prediction components predict what brands of clothing social media authors are interested in based on keywords in the posts that the inference component 304 detects. It will be appreciated that the more detailed the inferences (by using more complex algorithms in the inference component 30), the narrower the prediction may be. For example, if the inferences include detecting an author's sentiment about a topic, the prediction component may be able to predict that, while a topic is receiving a lot of attention, the attention it is receiving is negative, so the user 318 is likely to also dislike the topic.

It will further be appreciated that the prediction component 308 may use information about the user 318 to enhance the prediction. For example, the user 318 may use a browser 316 to access an ad-enabled site 314. The ad-enabled site 314 may acquire information about the user 318 from the browser 316. This information may include, for example, the user's 318 location (e.g., from the user's 318 internet protocol address), the user's 318 previous interest (e.g., from the user's 318 cookies), and/or the site the user 318 visited previous to the ad-enabled site 314 (e.g., a referral site). In one example, the location of the user 318 is known and the prediction component 308 uses posts that contain terms particular the surrounding geographical region (e.g., by inferring a social media author's demographics in the inference component 304) are used to more accurately predict what topics will be of interest to the user.

The selection component 310, selects an advertisement as a function of the user's 318 predicted interests as made by the prediction component 308. For example, if the prediction component 308 predicts that the user 318 may be interested in sports, and more particularly to a professional golfer who just won a tournament, an advertisement for a sport deodorant endorsed by the golfer may be selected by the selection component 310. In another example, an advertisement more relevant to seemingly unrelated topics is selected because both topics are hot topics at the instant the snapshot is taken. The selection component 310 may retrieve an advertisement from a storage component 312, for example, configured to store advertisements according to some predetermined criteria (e.g., according to tags used to describe the content of that advertisement and/or the advertisement's target audience). The advertisement selected may be displayed on the ad-enabled site 314 that the user 318 is viewing. It will be appreciated that where multiple advertisements are able to be displayed on the ad-enabled site 314, multiple advertisements may be selected by the selection component 310. The selection component 310 may, for example, select multiple advertisements relating to the same topic and/or may select advertisements from multiple topics that relate to the user's 318 predicted interests.

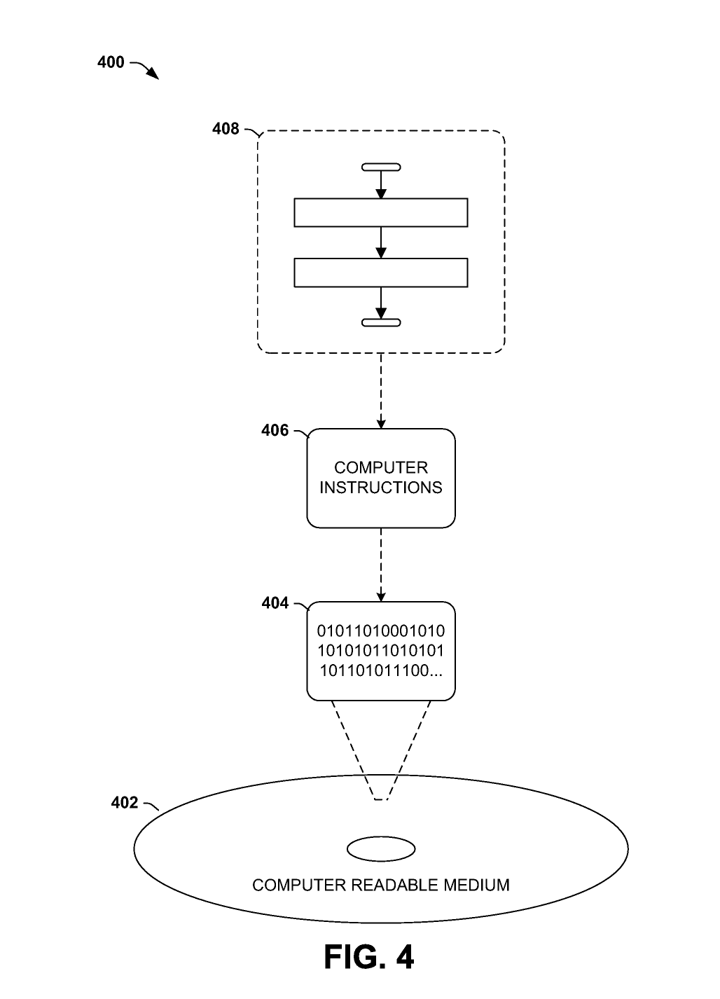

Still another embodiment involves a computer-readable medium comprising processor-executable instructions configured to implement one or more of the techniques presented herein. An exemplary computer-readable medium that may be devised in these ways is illustrated in FIG. 4, wherein the implementation 400 comprises a computer-readable medium 402 (e.g., a CD-R, DVD-R, or a platter of a hard disk drive), on which is encoded computer-readable data 404. This computer-readable data 404 in turn comprises a set of computer instructions 406 configured to operate according to one or more of the principles set forth herein. In one such embodiment 400, the processor-executable instructions 406 may be configured to perform a method, such as the exemplary methods 100 and 200 of FIGS. 1 and 2, for example. In another such embodiment, the processor-executable instructions 406 may be configured to implement a system, such as the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

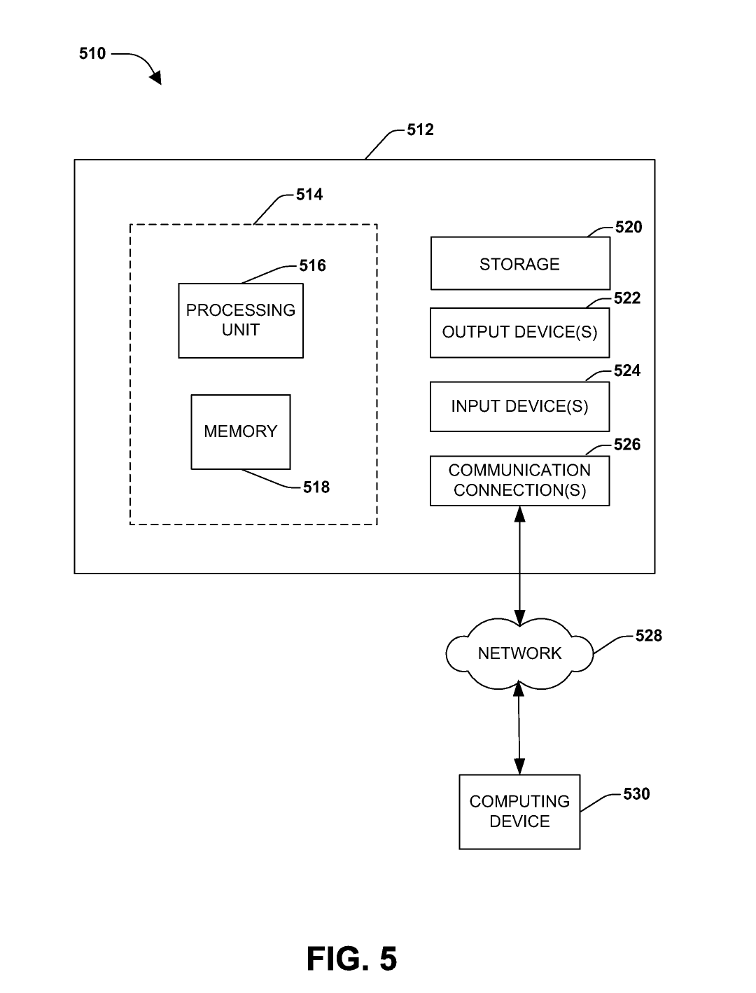

FIG. 5 and the following discussion provide a brief, general description of a suitable computing environment to implement embodiments of one or more of the provisions set forth herein. The operating environment of FIG. 5 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 5 illustrates an example of a system 510 comprising a computing device 512 configured to implement one or more embodiments provided herein. In one configuration, computing device 512 includes at least one processing unit 516 and memory 518. Depending on the exact configuration and type of computing device, memory 518 may be volatile (such as RAM, for example), non-volatile (such as ROM, flash memory, etc., for example) or some combination of the two. This configuration is illustrated in FIG. 5 by dashed line 514.

In other embodiments, device 512 may include additional features and/or functionality. For example, device 512 may also include additional storage (e.g., removable and/or non-removable) including, but not limited to, magnetic storage, optical storage, and the like. Such additional storage is illustrated in FIG. 5 by storage 520. In one embodiment, computer readable instructions to implement one or more embodiments provided herein may be in storage 520. Storage 520 may also store other computer readable instructions to implement an operating system, an application program, and the like. Computer readable instructions may be loaded in memory 518 for execution by processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 512. Any such computer storage media may be part of device 512.

Device 512 may also include communication connection(s) 526 that allows device 512 to communicate with other devices. Communication connection(s) 526 may include, but is not limited to, a modem, a Network Interface Card (NIC), an integrated network interface, a radio frequency transmitter/receiver, an infrared port, a USB connection, or other interfaces for connecting computing device 512 to other computing devices. Communication connection(s) 526 may include a wired connection or a wireless connection. Communication connection(s) 526 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 512 may include input device(s) 524 such as keyboard, mouse, pen, voice input device, touch input device, infrared cameras, video input devices, and/or any other input device. Output device(s) 522 such as one or more displays, speakers, printers, and/or any other output device may also be included in device 512. Input device(s) 524 and output device(s) 522 may be connected to device 512 via a wired connection, wireless connection, or any combination thereof. In one embodiment, an input device or an output device from another computing device may be used as input device(s) 524 or output device(s) 522 for computing device 512.

Components of computing device 512 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 512 may be interconnected by a network. For example, memory 518 may be comprised of multiple physical memory units located in different physical locations interconnected by a network.

Those skilled in the art will realize that storage devices utilized to store computer readable instructions may be distributed across a network. For example, a computing device 530 accessible via network 528 may store computer readable instructions to implement one or more embodiments provided herein. Computing device 512 may access computing device 530 and download a part or all of the computer readable instructions for execution. Alternatively, computing device 512 may download pieces of the computer readable instructions, as needed, or some instructions may be executed at computing device 512 and some at computing device 530.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for selecting an online advertisement to target a user, comprising:
identifying current topics in social media according to a first snapshot of the social media; and
selecting the online advertisement to target the user as a function of the current topics identified.

2. The method of claim 1, comprising acquiring a post from the online social media content using syndicated feed crawlers.

3. The method of claim 2, comprising categorizing the post acquired using some predetermined criteria.

4. The method of claim 3, wherein the predetermined criteria used to categorize the post is at least one of the following:
main topic of the post;
links in the post that point to another website;
keywords;
persons, places, or brands mentioned in the post;
sentiment of the author; and
demographics of the author.

5. The method of claim 3, wherein the post is categorized using inference algorithms.

6. The method of claim 5, wherein the inference algorithms are trained to infer the topic of a post and categorize it as a function of the inferred topic.

7. The method of claim 1, wherein an online advertisement is selected to reflect current, popular conversational topics.

8. The method of claim 1, wherein the online advertisement is selected in real-time to reflect current behavior.

9. The method of claim 1, comprising selecting an advertisement as a function of the user's known interest; wherein, the user's known interest are used to filter current topics that are more likely to be relevant to the user.

10. The method of claim 9, comprising determining the user's interests as a function of a site the user was referred from.

11. The method of claim 1, comprising:
tagging the online advertisement based on some predetermined criteria;
storing the online advertisement;
selecting the online advertisement when the advertisement's tag relates to current topics; and
displaying the selected online advertisement on an ad-enabled site.

12. The method of claim 1, comprising identifying current topics of online social media according to a second snapshot of the social media some predetermined time after the first snapshot or upon the occurrence of some predetermined event.

13. A method for selecting an online advertisement to target a user, comprising:
monitoring social media,
wherein inferences are made about the social media using some predetermined criteria,
wherein the predetermined criteria includes at least one of the following:
main topic of the post;
links in a post that point to another website;
keywords;
persons, places, or brands mentioned in the post;
sentiment of an author; and
demographics of the author;
taking a snapshot of social media,
wherein the snapshot acquires the data about the inferences made at an instant the snapshot is taken;
predicting the user's interests as a function of the data acquired by the snapshot,
wherein the data is used to find the current popular conversational topics; and
selecting the online advertisement as a function of the prediction,
wherein the selection is presented to a user on an ad-enabled site.

14. The method of claim 13, comprising enhancing the prediction as a function of the user's known characteristics.

15. The method of claim 13, wherein the advertisement is selected in real-time to reflect current behaviors.

16. The method of claim 13, wherein inferences are made using trained algorithms and rules.

17. A system for selecting an online advertisement to target a user, comprising:
an inference component configured to make inferences about social media
an acquisition component configured to take a snapshot of the inferences made by the inference component;
a prediction component configured to predict the user's interest as a function of the snapshot taken by the acquisition component; and
a selection component configured to select the online advertisement that relates to the user's predicted interests.

18. The system of claim 17, wherein the prediction component uses currently, popular conversational topics as determined by the snapshot to predict the user's interests.

19. The system of claim 17, wherein the prediction component is configured to enhance the prediction if characteristics of a user are known.

20. The system of claim 17, wherein the selection component is configured to automatically select an advertisement from a storage component and display the advertisement on an ad-enabled site.
